(19) United States
(12) Patent Application Publication
(10) Pub. No.: US 2025/0110763 A1
(43) Pub. Date: Apr. 3, 2025

(54) DATA PROCESSING SYSTEM AND DATA PROCESSING METHOD

(71) Applicant: SEMICONDUCTOR ENERGY LABORATORY CO., LTD., Atsugi-shi (JP)

(72) Inventors: Naoaki TSUTSUI, Atsugi (JP); Ryo NAKAZATO, Ebina (JP)

(21) Appl. No.: 18/897,744

(22) Filed: Sep. 26, 2024

(30) Foreign Application Priority Data
Sep. 29, 2023 (JP) 2023-169318

(51) Int. Cl. G06F 9/455; G06F 9/30

(52) U.S. Cl. CPC G06F 9/455; G06F 9/30181

(57) ABSTRACT

A novel data processing system composed of three data processing devices is provided. A first data processing device receives an instruction sentence, generates a processing result, and transmits the result including an intermediate code. A second data processing device receives a document, the processing result, and model data, generates the instruction sentence, and transmits the instruction sentence. The instruction sentence includes instructions relating to analysis of the document, extraction of a processing step, and conversion into the intermediate code. The second data processing device extracts the intermediate code from the processing result and transmits the intermediate code. A third data processing device receives the intermediate code, simulates the processing step in accordance with the intermediate code, and generates and transmits the model data.

### BACKGROUND OF THE INVENTION

### 1. Field of the Invention

One embodiment of the present invention relates to a data processing system and a data processing method.

Note that one embodiment of the present invention is not limited to the above technical field. The technical field of one embodiment of the invention disclosed in this specification and the like relates to an object, a method, or a manufacturing method. One embodiment of the present invention relates to a process, a machine, manufacture, or a composition of matter. Specific examples of the technical field of one embodiment of the present invention disclosed in this specification include a semiconductor device, a display apparatus, a light-emitting apparatus, a power storage device, a memory device, a method for driving any of them, and a method for manufacturing any of them.

### 2. Description of the Related Art

In recent years, language models using neural networks have been actively developed, and in particular, a large language model (LLM) have attracted attention. The large language model is a natural language processing model learned using a large amount of data. With the large language model, for example, an interaction model for responding to user's instructions can be achieved. In Non-Patent Document 1, GPT-4 (generative pre-trained transformer 4) is disclosed as a large language model, and ChatGPT is disclosed as an interaction model.

By utilizing the large language model, the capability of the natural language processing model has been significantly increased. Meanwhile, it is difficult to incorporate and operate a language model by oneself in terms of facilities and costs due to hugeness of the language model. Thus, utilizing an external service that provides a language model is one of the utility forms of the language model.

### REFERENCE

### Non-Patent Document

[Non-Patent Document 1] Yiheng Liu et al., Summary of ChatGPT/GPT-4 Research and Perspective Towards the Future of Large Language Models (Submitted on Apr. 4, 2023, [online] Internet <URL: https://arxiv.org/abs/2304.01852>

### SUMMARY OF THE INVENTION

One object of one embodiment of the present invention is to provide a novel data processing system that is highly convenient, useful, or reliable. Another object is to provide a novel data processing method that is highly convenient, useful, or reliable. Another object is to provide a novel data processing system, a novel data processing method, or a novel semiconductor device.

Note that the description of these objects does not preclude the existence of other objects. In one embodiment of the present invention, there is no need to achieve all of these objects. Other objects will be apparent from and can be derived from the description of the specification, the drawings, the claims, and the like.

### (1) One Embodiment of the Present Invention is a Data Processing System Including a First Data Processing Device, a Second Data Processing Device, and a Third Data Processing Device.

The first data processing device has a function of receiving an instruction sentence and a function of generating a processing result in accordance with the instruction sentence. The processing result includes an intermediate code. The first data processing device has a function of transmitting the processing result to the second data processing device.

The second data processing device has a function of receiving a document, the processing result, and model data, and the document includes information on a processing step. The second data processing device has a function of generating the instruction sentence and a function of transmitting the instruction sentence to the first data processing device. The instruction sentence includes a conversion rule and the document, and includes an instruction for analyzing the document to extract the processing step and an instruction for converting the processing step into the intermediate code in accordance with the conversion rule.

The second data processing device has a function of extracting the intermediate code from the processing result, a function of transmitting the intermediate code to the third data processing device, and a function of transmitting the model data to an information terminal.

The third data processing device has a function of receiving the intermediate code, a function of simulating the processing step in accordance with the intermediate code to generate the model data, and a function of transmitting the model data to the second data processing device.

Accordingly, a processing step can be extracted by analyzing a document written in natural language. The processing step extracted from the document can be converted into an intermediate code. The processing step extracted from the document can be simulated. Model data can be generated by simulating the processing step extracted from the document. A design tool assumed to be used by a user with advanced knowledge can be operated with the use of natural language. As a result, a novel data processing system that is highly convenient, useful, or reliable can be provided.

### (2) Another Embodiment of the Present Invention is a Data Processing System Including a First Data Processing Device, a Second Data Processing Device, and a Third Data Processing Device.

The first data processing device has a function of receiving an instruction sentence and a function of generating a processing result in accordance with the instruction sentence. The processing result includes an intermediate code. The first data processing device has a function of transmitting the processing result to the second data processing device.

The second data processing device has a function of receiving a document, the processing result, and model data, and the document includes information on a processing step. The second data processing device has a function of generating the instruction sentence and a function of transmitting the instruction sentence to the first data processing device. The instruction sentence includes an instruction for analyzing the document to extract the processing step and an instruction for converting the processing step into the intermediate code in accordance with the conversion rule.

The second data processing device has a function of extracting an intermediate code from the processing result and a function of generating a script file and a setting file in accordance with the intermediate code. The second data processing device has a function of transmitting the script file and the setting file to the third data processing device and a function of transmitting the model data to an information terminal.

The third data processing device has a function of receiving the script file and the setting file, a function of simulating the processing step in accordance with the script file and the setting file to generate the model data, and a function of transmitting the model data to the second data processing device.

Accordingly, a processing step can be extracted by analyzing a document written in natural language. The processing step extracted from the document can be converted into an intermediate code. A script file and a setting file in a variety of formats can be generated in accordance with the intermediate code. The script file and the setting file in a predetermined format can be generated in accordance with a design tool operated by the third data processing device. The processing step extracted from the document can be simulated. The model data can be generated by simulating the processing step extracted from the document. A design tool assumed to be used by a user with advanced knowledge can be operated with the use of natural language. As a result, a novel data processing system that is highly convenient, useful, or reliable can be provided.

(3) Another Embodiment of the Present Invention is the Above-Described Data Processing System in which the Second Data Processing Device Includes a Database.

Note that the database stores a recipe, and the second data processing device has a function of verifying the intermediate code using the recipe.

Accordingly, an error can be indicated by the verification of the intermediate code generated from the document written in natural language. Moreover, a design tool assumed to be used by a user with advanced knowledge can be operated with the use of natural language. As a result, a novel data processing system that is highly convenient, useful, or reliable can be provided.

### (4) Another Embodiment of the Present Invention is a Data Processing Method Including First to Sixteenth Steps Described Below.

In the first step, an information terminal receives a document and transmits the document to the first data processing device. Note that the document includes information on a processing step. In the second step, the first data processing device receives the document and stores the document.

In the third step, the first data processing device generates an instruction sentence and transmits the instruction sentence to the second data processing device. Note that the instruction sentence includes a conversion rule and the document, and includes an instruction for analyzing the document to extract the processing step and an instruction for converting the processing step into an intermediate code in accordance with the conversion rule. In the fourth step, the second data processing device receives the instruction sentence and stores the instruction sentence.

In the fifth step, the second data processing device generates a processing result in accordance with the instruction sentence and transmits the processing result to the first data processing device. Note that the processing result includes the intermediate code. In the sixth step, the first data processing device receives the processing result and stores the processing result.

In the seventh step, the first data processing device extracts the intermediate code from the processing result and verifies the intermediate code using a recipe. In the eighth step, in the case where an error is not detected in the intermediate code, processing proceeds to the ninth step, and in the case where an error is detected in the intermediate code, the processing proceeds to the sixteenth step.

In the ninth step, the first data processing device transmits the intermediate code to the third data processing device. In the tenth step, the third data processing device receives the intermediate code and stores the intermediate code.

In the eleventh step, the third data processing device simulates the processing step in accordance with the intermediate code and generates model data.

In the twelfth step, the third data processing device transmits the model data to the first data processing device, and in the thirteenth step, the first data processing device receives the model data and stores the model data.

In the fourteenth step, the first data processing device transmits the model data to the information terminal, and in the fifteenth step, the information terminal receives the model data and displays the model data.

Note that in the sixteenth step, the first data processing device notifies the information terminal of an occurrence of an error.

In this way, a design tool assumed to be used by a user with advanced knowledge can be operated with the use of natural language. As a result, a novel data processing method that is highly convenient, useful, or reliable can be provided.

Although the block diagram in drawings attached to this specification shows components classified based on their functions in independent blocks, it is difficult to classify actual components based on their functions completely, and one component can have a plurality of functions.

One embodiment of the present invention can provide a novel data processing system that is highly convenient, useful, or reliable. Another embodiment of the present invention can provide a novel data processing method that is highly convenient, useful, or reliable. Furthermore, a novel data processing system can be provided. Furthermore, a novel data processing method can be provided.

Note that the description of these effects does not preclude the existence of other effects. One embodiment of the present invention does not necessarily have all of these effects. Other effects will be apparent from and can be derived from the description of the specification, the drawings, the claims, and the like.

### BRIEF DESCRIPTION OF THE DRAWINGS

In the accompanying drawings:

FIG. 1 illustrates a structure of a data processing system of an embodiment.

FIG. 2 illustrates a structure of a document of an embodiment.

FIG. 3 illustrates a structure of an instruction sentence and a processing result of an embodiment.

FIG. 4 illustrates a structure of a stacked-layer film that can be manufactured by applying a processing step of an embodiment.

FIGS. 5A to 5F illustrate a model generated by a data processing system of an embodiment.

FIGS. 6A to 6E illustrate a model generated by a data processing system of an embodiment.

FIG. 7 illustrates a structure of a data processing system of an embodiment.

FIG. 8 illustrates a structure of a data processing device of an embodiment.

FIG. 9 illustrates a data processing method of an embodiment.

### DETAILED DESCRIPTION OF THE INVENTION

The data processing system of one embodiment of the present invention includes a first data processing device, a second data processing device, and a third data processing device. The first data processing device has a function of receiving an instruction sentence and a function of generating a processing result in accordance with the instruction sentence. The processing result includes an intermediate code. The first data processing device has a function of transmitting the processing result. The second data processing device has a function of receiving a document, a processing result, and model data. The document includes information on a processing step. The second data processing device has a function of generating the instruction sentence and a function of transmitting the instruction sentence. The instruction sentence includes a conversion rule and a document, and the instruction sentence includes an instruction for analyzing the document to extract the processing step and an instruction for converting the processing step into the intermediate code in accordance with the conversion rule. The second data processing device has a function of extracting the intermediate code from the processing result, a function of transmitting the intermediate code, and a function of transmitting the model data. The third data processing device has a function of receiving the intermediate code, a function of simulating the processing step in accordance with the intermediate code to generate the model data, and a function of transmitting the model data.

As a result, a novel data processing system that is highly convenient, useful, or reliable can be provided.

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Thus, the present invention should not be construed as being limited to the description in the following embodiments. Note that in structures of the invention described below, the same portions or portions having similar functions are denoted by the same reference numerals in different drawings, and the description thereof is not repeated.

### Embodiment 1

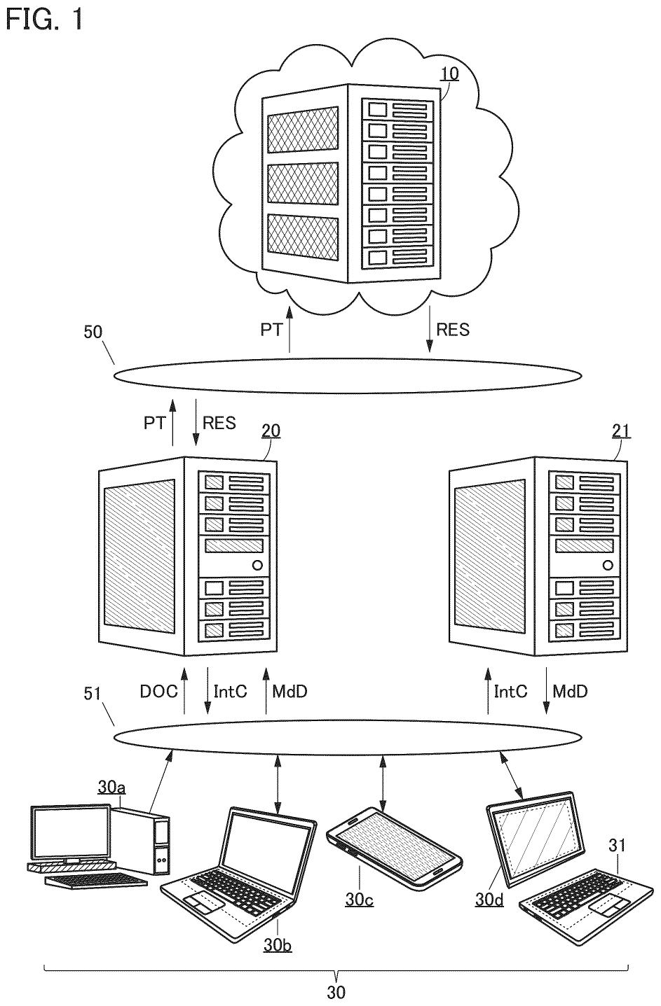

In this embodiment, a data processing system of one embodiment of the present invention is described with reference to FIGS. 1 to 4, FIGS. 5A to 5F, FIGS. 6A to 6E, and FIGS. 7 and 8.

FIG. 1 is a diagram illustrating a structure of the data processing system of one embodiment of the present invention.

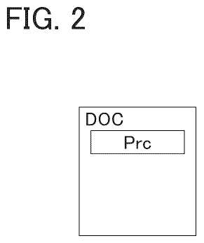

FIG. 2 is a diagram illustrating a structure of a document that can be handled by the data processing system of one embodiment of the present invention.

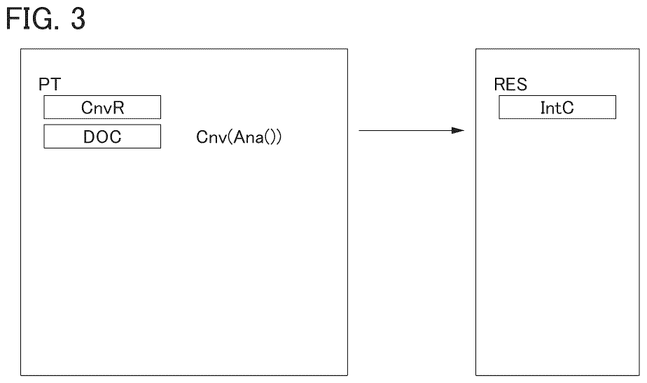

FIG. 3 is a diagram illustrating a structure of an instruction sentence and a processing result that are transmitted and received inside the data processing system of one embodiment of the present invention.

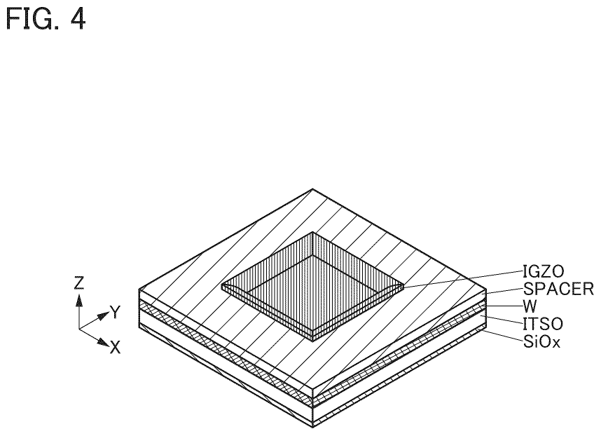

FIG. 4 is a perspective diagram illustrating a structure of a stacked-layer film that can be manufactured by applying a processing step simulated by the data processing system of one embodiment of the present invention.

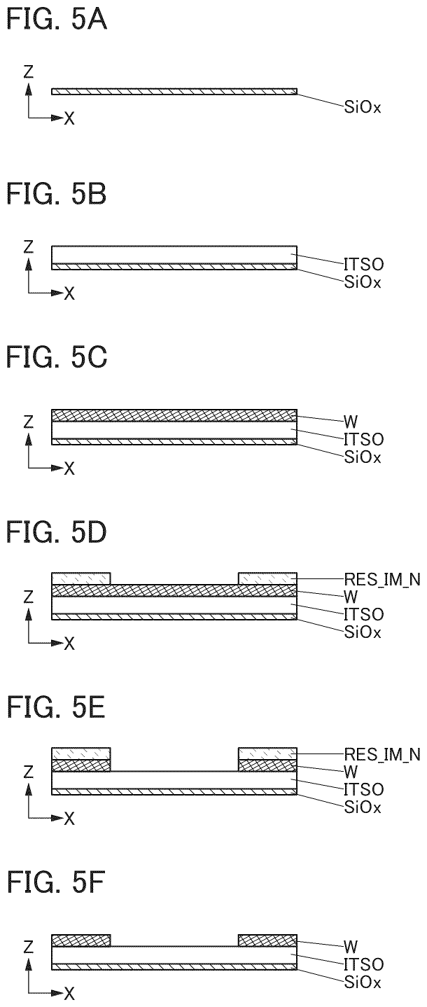

FIGS. 5A to 5F are cross-sectional views illustrating a model that can be generated by the data processing system of one embodiment of the present invention.

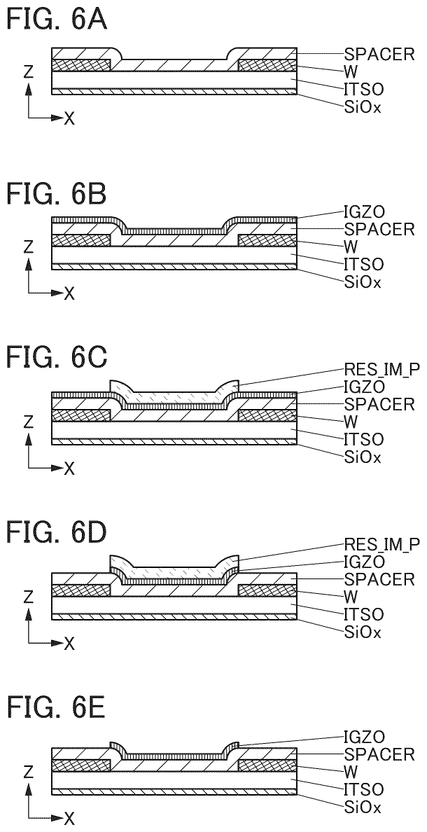

FIGS. 6A to 6E are cross-sectional views illustrating the model that can be generated by the data processing system of one embodiment of the present invention.

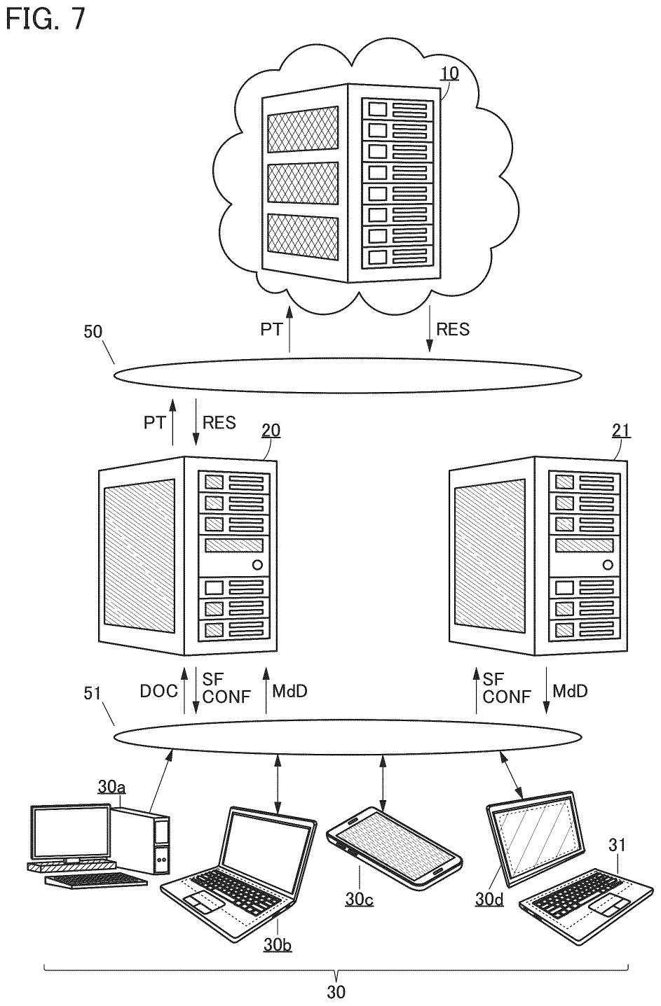

FIG. 7 is a diagram illustrating a structure of the data processing system of one embodiment of the present invention.

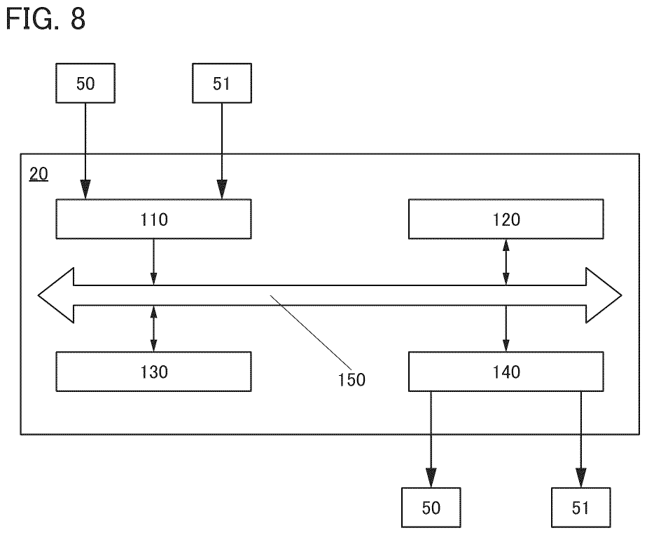

FIG. 8 is a block diagram illustrating a structure of a data processing device which can be used for the data processing system of one embodiment of the present invention.

### Structure Example 1 of Data Processing System

A data processing system of one embodiment of the present invention described in this embodiment includes a data processing device 10, a data processing device 20, and a data processing device 21 (see FIG. 1). Note that one or two data processing devices can have a function of the data processing device 10, a function of the data processing device 20, and a function of the data processing device 21. Alternatively, four or more data processing devices can have the function of the data processing device 10, the function of the data processing device 20, and the function of the data processing device 21. Reducing the number of data processing devices constituting the data processing system can reduce initial costs in some cases. Increasing the number of data processing devices constituting the data processing system sometimes enables processing in a distributed manner. In other words, the data processing system of one embodiment of the present invention includes a first functional module, a second functional module, and a third functional module. In this embodiment, description is made on the case where the data processing device 10 includes the first functional module, the data processing device 20 includes the second functional module, and the data processing device 21 includes the third functional module.

### Structure Example 1 of Data Processing Device 10

The data processing device 10 has a function of receiving an instruction sentence PT. The data processing device 10 also has a function of generating a processing result RES in accordance with the instruction sentence PT. Note that the processing result RES includes an intermediate code IntC (see FIG. 3). Note that data in which items and values corresponding to the items are stored can be used as the intermediate code IntC. In addition, a given data format can be used as long as keys and values can be stored with the format; for example, data written in a JavaScript Object Notation (abbreviation: JSON) format can be used as the intermediate code IntC.

Furthermore, the data processing device 10 has a function of transmitting the processing result RES. For example, transmission to the data processing device 20 via a network 50 is possible (see FIG. 1).

### Structure Example 1 of Data Processing Device 20

The data processing device 20 has a function of receiving a document DOC, the processing result RES, and model data MdD (see FIG. 1).

### Example of Document DOC

The document DOC includes information on a processing step Prc (see FIG. 2). For example, an expression in natural language can be used for the information on the processing step Prc; specifically, the information on a processing step for manufacturing a semiconductor device, a memory device, a display apparatus, or a secondary battery. Examples of the expression explaining the processing step, which can be used for the information on the processing step Prc, include “A material X is deposited to have a thickness of Y nm”, “Patterning is performed using a mask X”, “Patterning with a negative resist is performed using a mask X”, “A material X is etched to a depth of Y nm”, “A material X is entirely etched”, and “A resist is removed”. In addition, an expression explaining the order of processing can be added to the processing step Prc. Note that a user of the data processing system of one embodiment of the present invention can transmit the document DOC from the information terminal 30 to the data processing device 20, for example, via the network 50.

For example, the following text can be used as the document DOC: “SiOx is deposited to have a thickness of 10 nm. ITSO is deposited to have a thickness of 25 nm. W is deposited to have a thickness of 20 nm. Patterning with a negative resist is performed using an ISLAND mask. W is etched to a depth of 25 nm. The resist is removed. Then, SPACER is deposited to have a thickness of 20 nm. IGZO is deposited to have a thickness of 10 nm. Patterning is performed using the ISLAND mask. IGZO is entirely etched. The resist is removed”.

Note that the above document DOC includes eleven sentences, each of which corresponds to one processing step. In other words, the document DOC includes information on the processing step Prc including eleven processing steps. Furthermore, a stacked-layer film illustrated in FIG. 4 can be manufactured by employing the processing step, for example.

Note that SiOx refers to, for example, a layer including silicon oxide; ITSO refers to, for example, a layer including an oxide including indium-tin-silicon; W refers to, for example, a layer including tungsten; SPACER refers to, for example, a layer for making a gap between layers; and IGZO refers to, for example, a layer including an oxide including indium-gallium-zinc. ISLAND refers to, for example, a mask for making an island-shaped pattern by irradiation with light.

### Example of Instruction Sentence PT

The data processing device 20 has a function of generating the instruction sentence PT. The data processing device 20 also has a function of transmitting the instruction sentence PT. For example, transmission to the data processing device 10 via the network 50 is possible (see FIG. 1).

The instruction sentence PT includes a conversion rule CnvR and the document DOC (see FIG. 3). Note that the data processing device 20 may have a function of proofreading the document DOC. For example, when the document DOC includes a mistaken character, a missing character, or the like, the data processing device 20 can correct the mistaken character, the missing character, or the like.

An example of the conversion rule CnvR is a rule for converting an expression in natural language for explaining a proccing step, “a material X is deposited to have a thickness of Y nm” into an intermediate code, “{“kind”: “depo”, “property”: {“material”: X, “thickness”: Y, “mode”: “Conformal” }}”.

Another example of the conversion rule CnvR is a rule for converting an expression in natural language for explaining a proccing step, “Patterning is performed using a mask X” into an intermediate code, “{“kind”: “litho”, “property”: {“mask”: X, “reverse”: false}}”.

Another example of the conversion rule CnvR is a rule for converting an expression in natural language for explaining a proccing step, “Patterning with a negative resist is performed using a mask X” into an intermediate code, “{“kind”: “litho”, “property”: {“mask”: X, “reverse”: true}}”.

Another example of the conversion rule CnvR is a rule for converting an expression in natural language for explaining a proccing step, “A material X is etched by Y nm” into an intermediate code, “{“kind”: “etch_rect”, “property”: {“material”: X, “height”: Y, “mode”: “Max”, “angle”: 90}}”.

Another example of the conversion rule CnvR is a rule for converting an expression in natural language for explaining a proccing step, “A film of material X is entirely etched” into an intermediate code, “{“kind”: “etch_rect”, “property”: {“material”: X, “height”: 0, “mode”: “All”, “angle”: 90}}”.

Another example of the conversion rule CnvR is a rule for converting an expression in natural language for explaining a proccing step, “A resist is removed” into an intermediate code, “{“kind”: “strip”, “property”: { }}”.

The instruction sentence PT includes an instruction for analyzing the document DOC to extract the processing step Prc and an instruction for converting the processing step Prc into the intermediate code IntC in accordance with the conversion rule CnvR. Note that Cnv (Anao) shown in FIG. 3 represents an instruction sentence for converting a processing step obtained by analyzing a predetermined document into an intermediate code.

Furthermore, an output format of the processing result can be specified in the instruction sentence. Specifically, a JSON format can be specified as an output format, and a key can be supplied as a name of an item.

Specifically, the following instruction sentences can be used as the instruction sentence PT.

“The conversion rule for converting one sentence into one intermediate code is as follows. Note that a value corresponding to the original document is input to each of the letters X and Y.
Rule 1: a material X is deposited to have a thickness of Y nm.->{“kind”: “depo”, “property”: {“material”: X, “thickness”: Y, “mode”: “Conformal” }}.
Rule 2: patterning is performed using a mask X.->{“kind”: “litho”, “property”: {“mask”: X, “reverse”: false}}.
Rule 3: patterning with a negative resist is performed using the mask X.->{“kind”: “litho”, “property”: {“mask”: X, “reverse”: true}}.
Rule 4: the material X is etched by Y nm.->{“kind”: “etch_rect”, “property”: {“material”: X, “height”: Y, “mode”: “Max”, “angle”: 90}}.
Rule 5: the material X is entirely etched.->{“kind”: “etch_rect”, “property”: {“material”: X, “height”: 0, “mode”: “All”, “angle”: 90}}.
Rule 6: the resist is removed.->{“kind”: “strip”, “property”: { }}.

Analyze the next “input document” and write it in a JSON format in the intermediate code column in accordance with the above-described conversion rule.

Input document: “document DOC””.

Note that “Analyze the next “input document” and write it in a JSON format in the intermediate code column in accordance with the above-described conversion rule.” in the above instruction sentence PT includes an instruction for analyzing the document DOC to extract the processing step Prc and an instruction for converting the processing step Prc into the intermediate code IntC in accordance with the conversion rule CnvR. In addition, “input document” in the above instruction sentence PT is a headline, and texts in the document DOC is written in “document DOC” that follows the headline.

### Structure Example 2 of Data Processing Device 20

The data processing device 20 has a function of extracting the intermediate code IntC from the processing result RES. The data processing device 20 also has a function of transmitting the intermediate code IntC. For example, transmission to the data processing device 21 via a network 51 is possible (see FIG. 1).

The data processing device 20 has a function of transmitting the model data MdD. For example, transmission to the information terminal 30 via the network 51 is possible (see FIG. 1).

### Structure Example 1 of Data Processing Device 21

The data processing device 21 has a function of receiving the intermediate code IntC (see FIG. 1).

The data processing device 21 has a function of simulating the processing step Prc in accordance with the intermediate code IntC to generate the model data MdD.

Note that the model data MdD is data representing a model obtained by simulating the processing step Prc. For example, the data processing device 21 can simulate processing steps for stacking films on the XY plane and can generate a model of a stacked-layer film obtained through the processing steps. Furthermore, the data processing device 21 can cut the model of a stacked-layer film, which is formed on the XY plane in simulation, in the XZ plane intersecting with the XY plane so that data on a cross section of the model is generated. For example, a model of a stacked-layer film can be generated using an XYZ coordinate system or the like.

### Example of Intermediate Code IntC

Specifically, the data processing device 21 can generate a model of a stacked-layer film in accordance with the following intermediate code IntC. Note that the following intermediate code corresponds to the processing step Prc including eleven processing steps in the above-described document DOC.
“[
   {“kind”: “depo”, “property”: {“material”: “SiOx”, “thickness”: 10, “mode”: “Conformal” }},
   {“kind”: “depo”, “property”: {“material”: “ITSO”, “thickness”: 25, “mode”: “Conformal” }},
   {“kind”: “depo”, “property”: {“material”: “W”, “thickness”: 20, “mode”: “Conformal” }},
   {“kind”: “litho”, “property”: {“mask”: “ISLAND”, “reverse”: true}},
   {“kind”: “etch_rect”, “property”: {“material”: “W”, “height”: 25, “mode”: “Max”, “angle”: 90}},
   {“kind”: “strip”, “property”: { }},
   {“kind”: “depo”, “property”: {“material”: “SPACER”, “thickness”: 20, “mode”: “Conformal” }},
   {“kind”: “depo”, “property”: {“material”: “IGZO”, “thickness”: 10, “mode”: “Conformal” }},
   {“kind”: “litho”, “property”: {“mask”: “ISLAND”, “reverse”: false}},
   {“kind”: “etch_rect”, “property”: {“material”: “IGZO”, “height”: 0, “mode”: “All”, “angle”: 90}},
   {“kind”: “strip”, “property”: { }}
]”.

In the above-described intermediate code IntC, “{“kind”: “depo”, “property”: {“material”: “SiOx”, “thickness”: 10, “mode”: “Conformal” }}” corresponds to the step, “SiOx is deposited to have a thickness of 10 nm”. Note that the data processing device 21 can generate, for example, a model whose cross section is as illustrated in FIG. 5A by simulating the process. The generated model includes a layer SiOx. Note that the position of the model in the X-axis direction is shown in the horizontal direction of the drawing, and the thickness of the model in the Z-axis direction is shown in the vertical direction of the drawing.

In the above-described intermediate code IntC, “{“kind”: “depo”, “property”: {“material”: “ITSO”, “thickness”: 25, “mode”: “Conformal” }}” corresponds to the step, “ITSO is deposited to have a thickness of 25 nm”. Note that the data processing device 21 can generate, for example, a model whose cross section is as illustrated in FIG. 5B by simulating the process. The generated model includes the layer SiOx and a layer ITSO.

In the above-described intermediate code IntC, “{“kind”: “depo”, “property”: {“material”: “W”, “thickness”: 20, “mode”: “Conformal” }}” corresponds to the step, “W is deposited to have a thickness of 20 nm”. Note that the data processing device 21 can generate, for example, a model whose cross section is as illustrated in FIG. 5C by simulating the process. The generated model includes the layer SiOx, the layer ITSO, and a layer W.

In the above-described intermediate code IntC, “{“kind”: “litho”, “property”: {“mask”: “ISLAND”, “reverse”: true}}” corresponds to the step, “Patterning with a negative resist is performed using an ISLAND mask”. Note that the data processing device 21 can generate a model, for example, a model whose cross section is as illustrated in FIG. 5D by simulating the process. The generated model includes the layer SiOx, the layer ITSO, the layer W, and a resist RES_IM_N. Note that a region having a thickness and a region not having a thickness are formed in the resist RES_IM_N in the X-axis direction. The information on the thickness of the resist is stored in a mask, and the thickness of a predetermined region of the resist can be controlled using the mask. Furthermore, when ““reverse”: true” or ““reverse”: false” is specified in the intermediate code IntC, information stored in the mask can be inverted. Specifically, it is possible to specify whether the thickness of the resist is set to a predetermined thickness at a predetermined position and to zero at another position or whether the thickness of the resist is set to zero at the predetermined position and to a predetermined thickness at another position.

In the above-described intermediate code IntC, “{“kind”: “etch_rect”, “property”: {“material”: “W”, “height”: 25, “mode”: “Max”, “angle”: 90}}” corresponds to the step, “W is etched to a depth of 25 nm”. Note that the data processing device 21 can generate, for example, a model whose cross section is as illustrated in FIG. 5E by simulating the process.

In the above-described intermediate code IntC, “{“kind”: “strip”, “property”: { }}” corresponds to the step, “The resist is removed”. Note that the data processing device 21 can generate, for example, a model whose cross section is as illustrated in FIG. 5F by simulating the process.

In the above-described intermediate code IntC, “{“kind”: “depo”, “property”: {“material”: “SPACER”, “thickness”: 20, “mode”: “Conformal” }}” corresponds to the step, “SPACER is deposited to have a thickness of 20 nm”. Note that the data processing device 21 can generate, for example, a model whose cross section is as illustrated in FIG. 6A by simulating the process. The generated model includes the layer SiOx, the layer ITSO, the layer W, and a layer SPACER.

In the above-described intermediate code IntC, “{“kind”: “depo”, “property”: {“material”: “IGZO”, “thickness”: 10, “mode”: “Conformal” }}” corresponds to the step, “IGZO is deposited to have a thickness of 10 nm”. Note that the data processing device 21 can generate, for example, a model whose cross section is as illustrated in FIG. 6B by simulating the process. The generated model includes the layer SiOx, the layer ITSO, the layer W, the layer SPACER, and a layer IGZO.

In the above-described intermediate code IntC, “{“kind”: “litho”, “property”: {“mask”: “ISLAND”, “reverse”: false}}” corresponds to the step, “Patterning is performed using the ISLAND mask”. Note that the data processing device 21 can generate, for example, a model whose cross section is as illustrated in FIG. 6C by simulating the process. The generated model includes the layer SiOx, the layer ITSO, the layer W, the layer SPACER, the layer IGZO, and a resist RES_IM_P.

In the above-described intermediate code IntC, “{“kind”: “etch_rect”, “property”: {“material”: “IGZO”, “height”: 0, “mode”: “All”, “angle”: 90}}” corresponds to the step, “IGZO is entirely etched”. Note that the data processing device 21 can generate, for example, a model whose cross section is as illustrated in FIG. 6D by simulating the process.

In the above-described intermediate code IntC, “{“kind”: “strip”, “property”: { }}” corresponds to the step, “The resist is removed”. Note that the data processing device 21 can generate, for example, a model whose cross section is as illustrated in FIG. 6E by simulating the process.

The data processing device 21 has a function of transmitting the model data MdD. For example, transmission to the data processing device 20 via the network 51 is possible (see FIG. 1).

In this manner, the processing step Prc can be extracted by analyzing the document DOC written in natural language. The processing step Prc extracted from the document DOC can be converted into the intermediate code IntC. The processing step Prc extracted from the document DOC can be simulated. The model data MdD can be generated by simulating the processing step Prc extracted from the document DOC. A design tool assumed to be used by a user with advanced knowledge can be operated with the use of natural language. As a result, a novel data processing system that is highly convenient, useful, or reliable can be provided.

### Structure Example 2 of Data Processing System

Another data processing system of one embodiment of the present invention described in this embodiment includes the data processing device 10, the data processing device 20, and the data processing device 21 (see FIG. 7).

Note that the information processing system of one embodiment of the present invention described with reference to FIG. 7 is different from the data processing device described with reference to FIG. 1 in that the data processing device 20 has a function of generating a script file SF and a setting file CONF in accordance with the intermediate code IntC and a function of transmitting the files and that the data processing device 21 has a function of receiving the script file SF and the setting file CONF and simulating the processing step Prc in accordance with the files to generate the model data MdD. Different portions are described in detail here, and the above description is referred to for portions having the same structure as the above.

### Structure Example 3 of Data Processing Device 20

The data processing device 20 has a function of extracting the intermediate code IntC from the processing result RES. The data processing device 20 has a function of generating the script file SF and the setting file CONF in accordance with the intermediate code IntC. Note that scripts and settings are not necessarily stored in separate files, and a file storing the scripts and the settings can be generated.

The data processing device 20 also has a function of transmitting the script file SF and the setting file CONF. For example, transmission to the data processing device 21 via the network 51 is possible (see FIG. 7).

Furthermore, the data processing device 20 has a function of transmitting the model data MdD. For example, transmission to the information terminal 30 via the network 51 is possible (see FIG. 7).

### Structure Example 2 of Data Processing Device 21

The data processing device 21 has a function of receiving the script file SF and the setting file CONF (see FIG. 7).

The data processing device 21 has a function of generating the model data MdD by simulating the processing step Prc in accordance with the script file SF and the setting file CONF.

As the data processing device 21, for example, a data processing device that operates with a technology computer aided design (TCAD), an electronic design automation (EDA) tool, or the like can be used. Specifically, a data processing device that operates with TCAD (product name: Sentaurus Process Explorer) produced by Nihon Synopsys G.K. Inc., TCAD (product name: Clever) produced by Silvaco Japan Co., Ltd., or the like can be used as the data processing device 21.

The data processing device 21 has a function of transmitting the model data MdD. For example, transmission to the data processing device 20 via the network 51 is possible (see FIG. 7).

Thus, the processing step Prc can be extracted by analyzing the document DOC written in natural language. The processing step Prc extracted from the document DOC can be converted into the intermediate code IntC. The script file SF and the setting file CONF in a variety of formats can be generated in accordance with the intermediate code IntC. The script file SF and the setting file CONF in a predetermined format can be generated in accordance with a design tool operated by the data processing device 21. The processing step Prc extracted from the document DOC can be simulated. The model data MdD can be generated by simulating the processing step Prc extracted from the document DOC. A design tool assumed to be used by a user with advanced knowledge can be operated with the use of natural language. As a result, a novel data processing system that is highly convenient, useful, or reliable can be provided.

### Structure Example 4 of Data Processing Device 20

The data processing device 20 includes a database DB. Note that the database DB stores a recipe RCP. The recipe RCP includes a content of processing, a material to which the content of processing can be applied, the range of parameters applicable to the content of processing, and the like.

The data processing device 20 has a function of verifying the intermediate code IntC using the recipe RCP. For example, whether a content of processing in the intermediate code IntC is registered in the recipe RCP can be verified. Alternatively, whether the content of processing in the intermediate code IntC falls within the limited range registered in the recipe RCP can be verified.

The data processing device 20 has a function of notifying an occurrence of an error when a verification result is negative. For example, a message notifying the occurrence of an error is sent to the information terminal 30 via the network 51, so that the message can be displayed on the information terminal 30.

Thus, an error can be indicated by verification of the intermediate code IntC generated from the document DOC written in natural language. Moreover, a design tool assumed to be used by a user with advanced knowledge can be operated with the use of natural language. As a result, a novel data processing system that is highly convenient, useful, or reliable can be provided.

### Structure Example 3 of Data Processing System

Another data processing system of one embodiment of the present invention described in this embodiment includes the data processing device 10, the data processing device 20, and the data processing device 21 (see FIG. 1). The data processing system of one embodiment of the present invention also includes the information terminal 30. Note that there is no particular limitation on the number of the information terminals 30. For example, although four information terminals 30 are illustrated in FIG. 1, the number of the information terminals can be one, two, three, or five or more.

### Structure Example 5 of Data Processing Device 20

The data processing device 20 can transmit data received from the information terminal 30 to the data processing device 10. The data processing device 20 can also transmit data received from the data processing device 10 to the information terminal 30. Furthermore, the data processing device 20 can transmit data received from the data processing device 21 to the information terminal 30.

The data processing device 20 can process received data and transmit the result of the processing. For example, the data processing device 20 can execute processing using the data processing method of one embodiment of the present invention.

The data processing device 20 can transmit data generated in accordance with the data received from the information terminal 30 to the data processing device 10. The data processing device 20 can also transmit data generated in accordance with the data received from the data processing device 10 to the information terminal 30. Furthermore, the data processing device 20 can transmit data generated in accordance with the data received from the data processing device 21 to the information terminal 30.

Note that an organization such as a company that provides service using the data processing method of one embodiment of the present invention (hereinafter, such an organization is also referred to as a service provider) can provide service to a user with the use of the data processing device 20.

For example, a large computer such as a server computer or a supercomputer can be used as the data processing device 20.

A computer having a function of a parallel computer can be used as the data processing device 20. Thus, large-scale computation necessary for artificial intelligence (AI) learning and inference can be performed, for example. In addition, processing using a natural language processing model using AI can be performed.

### Structure Example 2 of Data Processing Device 10

The data processing device 10 can process received data and transmit a processing result. For example, processing such as calculation can be performed using data received from the data processing device 20. Furthermore, the data processing device 10 can transmit the processing result to the data processing device 20. Accordingly, the load of calculation on the data processing device 20 can be reduced.

The data processing device 10 can perform processing using a natural language processing model using AI. For example, processing using a natural language processing model using AI such as BERT (Bidirectional Encoder Representations from Transformers) or T5 (Text-to-Text Transfer Transformer) can be executed.

The data processing device 10 can perform processing using a model utilizing a large language model (a text generation model, an interaction model, or the like). For example, processing using a large language model such as GPT-3, GPT-3.5, GPT-4, LaMDA (Language Model for Dialogue Applications), PaLM (Pathways Language Model), or Llama2 can be executed. In particular, GPT-4 is preferably used.

For example, the data processing device 10 can convert a document written in natural language into intermediate codes written in intermediate language. The data processing device 10 can convert a document written in natural language into intermediate codes written in an intermediate language in accordance with the provided instruction sentences. Furthermore, conversion rules can be included in the instruction sentences. Thus, the degree of freedom of conversion can be controlled by applying the conversion rules.

The data processing device 10 can execute processing using a general-purpose language processing model capable of performing various natural language processing tasks.

The data processing device 10 is a large computer such as a server computer or a supercomputer. Furthermore, the data processing device 10 preferably has a function of a parallel computer. When the data processing device 10 is used as a parallel computer, large-scale computation necessary for AI learning and inference can be performed, for example.

Note that the data processing device 10 is a computer having higher processing capability than the data processing device 20. For example, in the case where both the data processing device 20 and the data processing device 10 have a function of a parallel computer, the data processing device 10 has higher processing capability than the data processing device 20 and thus can perform large-scale computation. For another example, in the case where both the data processing device 20 and the data processing device 10 can perform processing using a model utilizing a large-scale language model, the data processing device 10 can execute processing using a larger-scale AI model than the data processing device 20.

Note that the service provider do not necessarily have to have their own data processing device 10. For example, the service provider can use part of the service which another company or the like provides using the data processing device 10.

### <<Structure Example of Information Terminal 30

The information terminal 30 can receive data input by the user of the data processing system of one embodiment of the present invention. Moreover, the information terminal 30 can provide the user with data output from the data processing system of one embodiment of the present invention.

The information terminal 30 can transmit data received from a user to the data processing device 20. The information terminal 30 can provide the user with data received from the data processing device 20.

The information terminal 30 can transmit data generated in accordance with data received from a user to the data processing device 20. The information terminal 30 can provide the user with data generated in accordance with data received from the data processing device 20.

A dedicated application software or web browser is installed on the information terminal 30, for example. Via any of them, the user can access the data processing device 20. Thus, the user can receive service using the data processing system of one embodiment of the present invention with the use of a computer with lower processing capability than the data processing device 20, for example.

The information terminal 30 can also be referred to as a client computer or the like. Any type of the information terminal 30 is an information terminal device used by a user of the information processing system of one embodiment of the present invention.

For example, a desktop computer 30a, a notebook computer 30b, a smartphone 30c, and a tablet computer 30d can be used as the information terminal 30. Note that the tablet computer 30d can also be used as a laptop computer when connected to a housing 31 including a keyboard.

### Structure Example of Network 50

The network 50 connects the data processing device 20 and the data processing device 10. Thus, the input data and the processed data can be transmitted and received between the data processing device 20 and the data processing device 10. Furthermore, loads of the data processing can be dispersed.

Note that in this embodiment, the case where the network 50 is a larger computer network than the network 51 is mainly described. For example, a global network can be used as the network 50. Specifically, the Internet, which is an infrastructure of the World Wide Web (WWW), can be used.

### Structure Example of Network 51

The network 51 connects the plurality of information terminals 30, the data processing device 20, and the data processing device 21. Thus, data transmission and reception between them can be performed. Moreover, loads of the data processing can be dispersed. Furthermore, the service provider can provide a user with service using the data processing method of one embodiment of the present invention via the network 51, for example.

For example, a local network can be used as the network 51. An intranet or an extranet can also be used as the network 51. For another example, a personal area network (PAN), a local area network (LAN), a campus area network (CAN), a metropolitan area network (MAN), a wide area network (WAN), or a global area network (GAN) can be used as the network 51.

In the case where a service provider using the data processing method of one embodiment of the present invention and a user who receives the service belong to the same organization such as a company, data transmission and reception between the information terminal 30 and the data processing device 20 are preferably performed using the network 51 formed in the organization, for example. In this way, data transmission and reception between the information terminal 30 and the data processing device 10 can be performed more safely than in the case where they are performed via the Internet. Furthermore, confidential information in the organization can be prevented from being leaked to the outside.

Note that for wireless communication, it is possible to use, as a communication protocol or a communication technology, a communication standard such as the fourth-generation mobile communication system (4G), the fifth-generation mobile communication system (5G), or the sixth-generation mobile communication system (6G), or a communication standard developed by IEEE such as Wi-Fi (registered trademark) or Bluetooth (registered trademark).

### Structure Example 6 of Data Processing Device 20

The data processing device 20 includes an input unit 110, a storage unit 120, a processing unit 130, an output unit 140, and a transmission path 150 (see FIG. 8).

Although the block diagram in drawings attached to this specification illustrates components classified by their functions in independent blocks, it is difficult to classify actual components by their functions completely, and one component can have a plurality of functions. For example, part of the processing portion 130 functions as the input unit 110 in some cases. In addition, one function can be involved in a plurality of components. For example, processing performed in the processing unit 130 is sometimes executed by a different data processing device depending on the processing.

### [Input Unit 110]

The input unit 110 can receive data from the outside of the data processing device 20. For example, the input unit 110 receives data from the network 50 or the network 51.

The input unit 110 supplies the received data to one or both of the storage unit 120 and the processing unit 130 via the transmission path 150.

### [Storage Unit 120]

The storage unit 120 has a function of storing a program to be executed by the processing unit 130. The storage unit 120 can also have a function of storing data generated by the processing unit 130 (e.g., a calculation result, an analysis result, or an inference result), data received by the input unit 110, and the like.

The storage unit 120 can include a database. The data processing device 20 can include a database in addition to the memory unit 120. The data processing device 20 can have a function of extracting data from a database outside the storage unit 120, the data processing device 20, or the data processing system. Alternatively, the data processing device 20 can have a function of extracting data from both of its own database and an external database.

One or both of a storage and a file server can be used as the storage unit 120. In addition, a database in which a path of a file stored in the file server is recorded can be used as the storage unit 120.

The storage unit 120 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase change random access memory (PRAM), a ferroelectric random access memory (FeRAM), a magnetoresistive random access memory (MRAM, also referred to as a magnetoresistive memory), and a flash memory. The storage unit 120 can include at least one of a NOSRAM (registered trademark) and a DOSRAM (registered trademark). The storage unit 120 can include a storage media drive. Examples of the recording media drive include a hard disk drive (HDD) and a solid state drive (SSD).

Note that “NOSRAM” is an abbreviation for “nonvolatile oxide semiconductor random access memory (RAM)”. The NOSRAM refers to a memory in which a 2-transistor (2T) or 3-transistor (3T) gain cell is used as a memory cell and the transistor includes a metal oxide in its channel formation region (such a transistor is also referred to as an OS transistor). The OS transistor has an extremely low current that flows between a source and a drain in an off state, that is, an extremely low leakage current. The NOSRAM can be used as a nonvolatile memory by retaining electric charge corresponding to data in memory cells, using characteristics of extremely low leakage current. In particular, the NOSRAM is capable of reading retained data without destruction (non-destructive reading), and thus is suitable for arithmetic processing in which only a data reading operation is repeated many times. The NOSRAM can have large data capacity when being stacked in layers; accordingly, when the NOSRAM is used as a large-scale cache memory, a main memory, or a storage memory, the performance of the semiconductor device can be increased.

The DOSRAM is an abbreviation of “dynamic oxide semiconductor RAM”, which is a RAM including a 1T1C (one-transistor/one-capacitor) memory cell. The DOSRAM is a DRAM formed using an OS transistor, which temporarily stores data sent from the outside. The DOSRAM is a memory utilizing low off-state current of OS transistors.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably includes indium (In). When the metal oxide included in the channel formation region is a metal oxide including indium, the carrier mobility (electron mobility) of the OS transistor is high. The metal oxide included in the channel formation region is preferably an oxide semiconductor including an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M is, for example, an element that has higher bonding energy with oxygen than indium is. The metal oxide included in the channel formation region is preferably a metal oxide containing zinc (Zn). The metal oxide including zinc is easily crystallized in some cases.

The metal oxide included in the channel formation region is not limited to the metal oxide including indium. The metal oxide in the channel formation region may be, for example, a metal oxide that does not include indium and includes any of zinc, gallium, and tin (e.g., zinc tin oxide and gallium tin oxide).

### [Processing Unit 130]

The processing unit 130 has a function of performing processing such as calculation, analysis, and inference with the use of data supplied from one or both of the input unit 110 and the storage unit 120. The processing unit 130 can supply generated data (e.g., a calculation result, an analysis result, or an inference result) to one or both of the storage unit 120 and the output unit 140.

The processing unit 130 has a function of obtaining data from the storage unit 120. The processing unit 130 also has a function of storing or registering data in the storage unit 120.

The processing unit 130 can include an arithmetic circuit, for example. The processing unit 130 can include, for example, a central processing unit (CPU). The processing unit 130 can also include a graphics processing unit (GPU). Furthermore, the processing unit 130 can include an NPU (neural processing unit/neural network processing unit).

The processing unit 130 can include a microprocessor such as a digital signal processor (DSP). The microprocessor can be achieved with a programmable logic device (PLD) such as a field programmable gate array (FPGA) or a field programmable analog array (FPAA). The processing unit 130 can also include a quantum processor. With a processor, the processing unit 130 can interpret and execute instructions from various kinds of programs to process various kinds of data and control programs. The programs to be executed by the processor are stored in at least one of the storage unit 120 and a memory region of the processor.

The processing unit 130 can include a main memory. The main memory includes at least one of a volatile memory such as a random access memory (RAM) and a nonvolatile memory such as a read only memory (ROM). The main memory can include at least one of the above-described NOSRAM and DOSRAM.

Examples of the RAM include a DRAM and an SRAM; a virtual memory space is assigned and utilized as a working space of the processing unit 130. An operating system, an application program, a program module, program data, a look-up table, and the like which are stored in the storage unit 120 are loaded into the RAM for execution. The data, program, and program module which are loaded into the RAM are each directly accessed and operated by the processing unit 130.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultra-violet erasable programmable read only memory (UV-EPROM) which can erase stored data by irradiation with ultraviolet rays, an electrically erasable programmable read only memory (EEPROM), and a flash memory.

The processing unit 130 can include one or both of an OS transistor and a transistor including silicon in its channel formation region (Si transistor).

The processing unit 130 preferably includes an OS transistor. The OS transistor has an extremely low off-state current; thus, with the use of the OS transistor as a switch for retaining electric charge (data) that has flowed into a capacitor functioning as a memory element, a long data retention period can be ensured. When at least one of a register and a cache memory included in the processing unit has such a feature, the processing unit can be operated only when needed, and otherwise can be off while data processed immediately before turning off the processing unit is stored in the memory element. In other words, normally-off computing is possible and the power consumption of the data processing system can be reduced.

The data processing device 20 preferably uses AI for at least part of its processing.

In particular, the data processing device 20 preferably uses an artificial neural network (ANN; hereinafter also simply referred to as a neural network). The neural network can be constructed with circuits (hardware) or programs (software).

In this specification and the like, the neural network indicates a general model having the capability of solving problems, which is modeled on a biological neural network and determines the connection strength of neurons by learning. The neural network includes an input layer, a middle layer (hidden layer), and an output layer.

In the description of the neural network in this specification and the like, determining a connection strength of neurons (also referred to as weight coefficients) from the existing information is referred to as “leaning” in some cases.

In this specification and the like, drawing a new conclusion from a neural network formed with the connection strength obtained by learning is referred to as “inference” in some cases.

### [Output Unit 140]

The output unit 140 can output at least one of an arithmetic result, an analysis result, and an inference result in the processing unit 130 to the outside of the data processing device 20. For example, the output unit 140 can transmit data to the network 50 or the network 51.

### [Transmission Path 150]

The transmission path 150 has a function of transmitting data. Data transmission and reception between the input unit 110, the storage unit 120, the processing unit 130, and the output unit 140 can be performed via the transmission path 150.

### Structure Example 3 of Data Processing Device 21

For example, a structure similar to that of the data processing device described with reference to FIG. 8 can be used for the data processing device 21.

Note that this embodiment can be combined with any of the other embodiments in this specification as appropriate.

### Embodiment 2

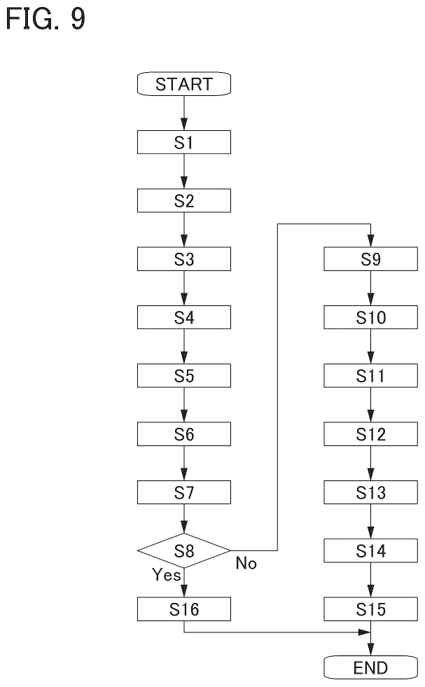

In this embodiment, a data processing method of one embodiment of the present invention will be described with reference to FIG. 9.

FIG. 9 illustrates the data processing method of one embodiment of the present invention.

### Example of Data Processing Method

The data processing method described in this embodiment includes Step S1 to Step S16 described below (see FIG. 9).

Step S1 and Step S2 are processing in which the document DOC received by the information terminal 30 is stored in the data processing device 20.

Step S3 and Step S4 are processing in which the data processing device 20 generates the instruction sentence PT from the document DOC and stores the instruction sentence PT in the data processing device 10.

Step S5 and Step S6 are processing in which the data processing device 10 generates a processing result in accordance with the instruction sentence PT and stores the processing result in the data processing device 20.

Step S7 and Step S8 are processing in which the data processing device 20 extracts an intermediate code from the processing result and verifies the intermediate code. Note that the processing proceeds to Step S9 in the case where there is no error in the intermediate code, and the processing proceeds to Step S16 in the case where there is an error.

Step S9 and Step S10 are processing in which the data processing device 20 transmits the intermediate code and stores the intermediate code in the data processing device 21.

Step S11 is processing in which the data processing device 21 generates model data in accordance with the intermediate code.

Step S12 and Step S13 are processing in which the data processing device 21 transmits the model data and stores the model data in the data processing device 20.

Step S14 and Step S15 are processing in which the model data is transmitted by the data processing device 20 and displayed on the information terminal 30.

Step S16 is processing in which the data processing device 20 notifies the occurrence of an error.

### [Step S1]

In Step S1, the information terminal 30 receives and transmits the document DOC (see FIG. 9). Note that the document DOC includes information on the processing step Prc. For example, transmission to the data processing device 20 via the network 51 is possible (see FIG. 1).

### [Step S2]

In Step S2, the data processing device 20 receives and stores the document DOC (see FIG. 9).

### [Step S3]

In Step S3, the data processing device 20 generates and transmits the instruction sentence PT (see FIG. 9). For example, transmission to the data processing device 10 via the network 50 is possible (see FIG. 1).

Note that the instruction sentence PT includes the conversion rule CnvR and the document DOC. The instruction sentence PT includes an instruction for analyzing the document DOC to extract the processing step Prc and an instruction for converting the processing step Prc into the intermediate code IntC in accordance with the conversion rule CnvR.

### [Step S4]

In Step S4, the data processing device 10 receives and stores the instruction sentence PT (see FIG. 9).

### [Step S5]

In Step S5, the data processing device 10 generates the processing result RES in accordance with the instruction sentence PT and transmits the processing result RES (see FIG. 9). For example, transmission to the data processing device 20 via the network 50 is possible (see FIG. 1). Note that the processing result RES includes the intermediate code IntC.

### [Step S6]

In Step S6, the data processing device 20 receives and stores the processing result RES (see FIG. 9).

### [Step S7]

In Step S7, the data processing device 20 extracts the intermediate code IntC from the processing result RES and verifies the intermediate code IntC using the recipe RCP (see FIG. 9).

### [Step S8]

In Step S8, the processing proceeds to Step S9 in the case where an error is not detected in the intermediate code IntC, and the processing proceeds to Step S16 in the case where an error is detected in the intermediate code IntC (see FIG. 9).

### [Step S9]

In Step S9, the data processing device 20 transmits the intermediate code IntC (see FIG. 9). For example, transmission to the data processing device 21 via the network 51 is possible (see FIG. 1).

### [Step S10]

In Step S10, the data processing device 21 receives and stores the intermediate code IntC (see FIG. 9).

### [Step S11]

In Step S11, the data processing device 21 simulates the processing step Prc in accordance with the intermediate code IntC and generates the model data MdD (see FIG. 9).

### [Step S12]

In Step S12, the data processing device 21 transmits the model data MdD (see FIG. 9). For example, transmission to the data processing device 20 via the network 51 is possible (see FIG. 1).

### [Step S13]

In Step S13, the data processing device 20 receives and stores the model data MdD (see FIG. 9).

### [Step S14]

In Step S14, the data processing device 20 transmits the model data MdD (see FIG. 9). For example, transmission to the information terminal 30 via the network 51 is possible (see FIG. 1).

### [Step S15]

In Step S15, the information terminal 30 receives and displays the model data MdD (see FIG. 9).

### [Step S16]

In Step S16, the data processing device 20 notifies the occurrence of an error (see FIG. 9). For example, a message notifying the occurrence of an error is sent to the information terminal 30 via the network 51, so that the message can be displayed on the information terminal 30.

In this way, a design tool assumed to be used by a user with advanced knowledge can be operated with the use of natural language. As a result, a novel data processing method that is highly convenient, useful, or reliable can be provided.

Note that this embodiment can be combined with any of the other embodiments in this specification as appropriate.

This application is based on Japanese Patent Application Serial No. 2023-169318 filed with Japan Patent Office on Sep. 29, 2023, the entire contents of which are hereby incorporated by reference.

What is claimed is:

1. A data processing system comprising:
a first data processing device;
a second data processing device; and
a third data processing device,
wherein the first data processing device is configured to receive an instruction sentence generated by the second data processing device,
wherein the first data processing device is configured to generate a processing result comprising an intermediate code in accordance with the instruction sentence and to transmit the processing result to the second data processing device,
wherein the second data processing device is configured to receive a document comprising information on a processing step, the processing result, and model data,
wherein the instruction sentence comprises a conversion rule and the document,
wherein the instruction sentence comprises an instruction for analyzing the document to extract the processing step and an instruction for converting the processing step into the intermediate code in accordance with the conversion rule,
wherein the second data processing device is configured to extract the intermediate code from the processing result,
wherein the second data processing device is configured to transmit the intermediate code to the third data processing device and to transmit the model data to an information terminal,
wherein the third data processing device is configured to simulate the processing step in accordance with the intermediate code and to generate the model data, and
wherein the third data processing device is configured to transmit the model data to the second data processing device.

2. A data processing system comprising:
a first data processing device;
a second data processing device; and
a third data processing device,
wherein the first data processing device is configured to receive an instruction sentence generated by the second data processing device,
wherein the first data processing device is configured to generate a processing result comprising an intermediate code in accordance with the instruction sentence and to transmit the processing result to the second data processing device,
wherein the second data processing device is configured to receive a document comprising information on a processing step, the processing result, and model data,
wherein the instruction sentence comprises a conversion rule and the document,
wherein the instruction sentence comprises an instruction for analyzing the document to extract the processing step and an instruction for converting the processing step into the intermediate code in accordance with the conversion rule,
wherein the second data processing device is configured to extract the intermediate code from the processing result,
wherein the second data processing device is configured to generate a script file and a setting file in accordance with the intermediate code and to transmit the script file and the setting file to the third data processing device,
wherein the second data processing device is configured to transmit the model data to an information terminal,
wherein the third data processing device is configured to simulate the processing step in accordance with the script file and the setting file and to generate the model data, and
wherein the third data processing device is configured to transmit the model data to the second data processing device.

3. The data processing system according to claim 1,
wherein the second data processing device comprises a database,
wherein the database stores a recipe, and
wherein the second data processing device is configured to verify the intermediate code using the recipe.

4. A data processing method comprising:
a first step in which an information terminal receives a document comprising information on a processing step and transmits the document to a first data processing device;
a second step in which the first data processing device receives and stores the document;
a third step in which the first data processing device generates an instruction sentence and transmits the instruction sentence comprising a conversion rule and the document to a second data processing device to store the instruction sentence;
a fourth step in which the second data processing device generates a processing result in accordance with the instruction sentence comprising an instruction for analyzing the document to extract the processing step and an instruction for converting the processing step into an intermediate code in accordance with the conversion rule and transmits the processing result comprising the intermediate code to the first data processing device to be stored;
a fifth seventh step in which the first data processing device extracts the intermediate code from the processing result and verifies the intermediate code using a recipe;
a sixth step in which the first data processing device transmits the intermediate code to a third data processing device to store the intermediate code in the case where no error has been detected in the intermediate code;
a seventh step in which the third data processing device simulates the processing step in accordance with the intermediate code and generates model data;
an eighth step in which the third data processing device transmits the model data to the first data processing device to store the model data;
a ninth step in which the first data processing device transmits the model data to the information terminal; and
a tenth step in which the information terminal displays the model data.

5. The data processing method according to claim 4,
wherein in the sixth step, the processing proceeds to an eleventh step in the case where an error has been detected in the intermediate code, and
wherein in the eleventh step, the first data processing device notifies the information terminal of an occurrence of the error.

6. The data processing system according to claim 2,
wherein the second data processing device comprises a database,
wherein the database stores a recipe, and
wherein the second data processing device is configured to verify the intermediate code using the recipe.
